(19) United States
(12) Patent Application Publication
(10) Pub. No.: US 2024/0232934 A1
(43) Pub. Date: Jul. 11, 2024

(54) SYSTEMS AND METHODS FOR SUSTAINABILITY-BASED TRANSACTIONAL PROCESSING AND REWARD AUTOMATION

(71) Applicant: Capital One Services, LLC, McLean, VA (US)

(72) Inventors: Xiaoguang ZHU, New York, NY (US); Samuel RAPOWITZ, Roswell, GA (US); Lin Ni Lisa CHENG, Fresh Meadows, NY (US)

(21) Appl. No.: 18/095,964

(22) Filed: Jan. 11, 2023

(51) Int. Cl. G06Q 30/0234; G06Q 10/087; G06Q 20/20

(52) U.S. Cl. CPC G06Q 30/0234; G06Q 10/087; G06Q 20/20

(57) ABSTRACT

Systems and methods for implementing a dynamic cashback adjustment rates based on environmental and social impact derived a user's transactional data are disclosed. The described operations leverage a sustainability scoring model based on user's transactional data to derive three input parameters for quantifying a measures of sustainability factor and environmental impact associated with the user's transactional behavior and purchasing pattern. The computed sustainability score may then be used to generates a ranking based on a user's environmental impact as derived from their transactional activity. The generated ranking is then used to automate cash-back rewards to further incentivize sustainable transactional practices.

### FIELD OF THE DISCLOSURE

The present disclosure relates to systems and methods for automation of electronic cashback services based on an analysis of user transactional behavior, and more specifically to automation of financial reward process for incentivizing sustainable transactional behavior associated with a reduced environmental impact.

### BACKGROUND

Environmental, social, and governance (ESG) concerns have become an important factor in business and investment decisions. Companies are becoming increasingly focused on reducing their environmental impact. Many organizations have set aggressive ESG and carbon neutrality goals and work to achieve these goals through high quality carbon offset programs.

Historically, factors deriving ESG impact have been implemented at the corporate level such as buying carbon offsite for the company. However, such approaches lack any mechanism to also incentivize individuals such as service users and customers towards a more sustainable transactional behavior in line with lower ESG impact.

These and other deficiencies exist. As such, there is a need for an automation process to incentivize user transactional behavior in line with ESG impact reduction goals.

### SUMMARY OF THE DISCLOSURE

One aspect of the present disclosure is directed to an automated process for quantifying a sustainability factor associated with user transactional data, the method comprising: linking a transaction aggregator to one or more financial accounts associated with a user, to retrieve a transaction history of the user. The method further comprises retrieving, from one or more Point Of Sale (POS) devices, one or more transaction strings comprising product data associated with one or more transactions conducted by the user. The user transactional activity comprising of the transaction history, retrieved via a transaction aggregator, and the one or more transaction strings and product metadata, retrieved from the one or more POS devices, may then be processed by an ESG impact analyzer to quantify a sustainability factor associated with a user's transactional behavior. The measure of the sustainability factor, associated with user's transactional activity, may then be used to automated a cashback and/or reward process.

The processing of the user's transactional behavior to compute a corresponding sustainability factor and/or ESG impact may involve identifying a first set of data associated with one or more product metadata tags that are indicative of one or more sustainability related product attributes. The product metadata may be extracted from transaction string data provided by a plurality POS devices. The data from the plurality of POS devices may be retrieved using a payment gateway and/or a payment processor. The one or more POS device may insert the sustainability-related product metadata tags in the corresponding transaction strings generated by the device. The relevant metadata tags may also be transmitted, by a respective POS device and/or a merchant system, via a separate data stream (e.g., separate from an initial transaction string generated by the POS device) In some embodiments, a product catalog engine may be used to identify and retrieve one or more sustainability product metadata records based on, for example, a Stock Keeping Unit (SKU) identifier that may be provided, as part of transactional data, by a POS device.

In some embodiments of the present disclosure, the metadata associated with sustainability-related attributes of a product (e.g., the first set of data) may be obtained via a user feedback acquisition process. For example, product sustainability attribute data may be obtained from one or more scanned copied of transaction receipts and or product image data captured by a user device and transmitted to a user-feedback interface associated with the ESG impact analyzer.

In addition to the first set of data, corresponding to a product's sustainability-related attributes, the ESG impact analyzer may further parse and process a user's historical transaction records, retrieved by the transaction aggregator linked to one or more user financial accounts user. The retrieved transactional records, corresponding to a second set of data, may then be parsed and processed to compute a second sustainability input parameter as a function of online to in-person and bulk to retail transaction ratios. A transaction record may include data that identifies a transaction as a Card Present (CP) or Card Not Present (CNP) transaction. This information may be used to compute the aforementioned ratio of online (e.g. CNP) to in-person (e.g. CP) transactions conducted by the user. For example, a greater ratio of on-line to in-person transactions may be indicative of a more sustainable transactional behavior with a smaller ESG impact. Moreover, the transaction amounts, extracted from user transaction records, may be used to compute a ratio of bulk to retail transactions. For example, a greater ratio of bulk to retail transactions may be indicative of a more sustainable transactional behavior with a smaller ESG impact.

In addition to the first and second sets of data, corresponding to a product's sustainability-related attributes and user's bulk-to-retail and/or CNP-to-CP transactional pattern, the ESG impact analyzer may further identify one or more merchants associated with the user transactional activity, and determine a third set of data corresponding to one or more sustainability credentials of the one or more merchants. A sustainability factor and an environmental impact footprint, associated with a user's transactional behavior may then be computed as a function of the first, second and third sets of data. In some embodiments, a rank score may be computed for the user based on the computed sustainability and environmental impact scores, relative to a plurality of other users. The computed sustainability ranking of the user may then be configured as a basis for automation of cashback rewards to further incentivize sustainable and environmentally friendly transactional practices.

One aspect of the present disclosure is directed to an ESG-driven dynamic cashback system which automates a cashback reward process based on computing a sustainability factor and an environmental impact associated with a user transactional activity. The system comprises a computer hardware arrangement configure to: link a transaction aggregator to one or more financial accounts associated with a user (to retrieve a transaction history of the user) and one or more transaction strings comprising sustainability-related product metadata, from one or more Point Of Sale (POS) devices. The system may be further configured to process the transaction history and the one or more transaction strings to: identify a first set of data associated with one or more product metadata tags indicative of one or more sustainability related product attribute, identify one or more merchants associated with a transactional activity of the user, compute a second set of data comprising a ratio of online to in-person transactions, and a ratio of bulk to retail transactions, associated with the user.

The system may be further configured to retrieve a third set of data corresponding to one or more sustainability credentials of the one or more merchants associated with the transactional activity of the user and compute a sustainability score as a function of the first set of data, the second set data, and the third set of data, Based on the computed sustainability score, the system may generate a ranking score for the user relative to a plurality of other users. The sustainability score and/or the ranking score may then be used by the system to automate a cashback reward to further incentivize sustainable transactional practices by the user.

One aspect of the present disclosure is directed to a non-transitory computer-accessible medium comprising instructions for execution by a computer hardware arrangement, wherein upon execution of the instructions the computer hardware arrangement is configured to perform procedure comprising: linking a transaction aggregator to one or more financial accounts associated with a user, to retrieve a transaction history of the user, retrieving, from one or more Point Of Sale (POS) devices, one or more transaction strings comprising product data associated with one or more transactions conducted by the user, processing the transaction history and the one or more transaction strings to: identify a first set of data associated with one or more product metadata tags indicative of one or more sustainability related product attributes, identify one or more merchants associated with a transactional activity of the user, compute a second set of data comprising a ratio of online to in-person transactions, and a ratio of bulk to retail transactions, associated with the user, retrieving a third set of data corresponding to one or more sustainability credentials of the one or more merchants associated with the transactional activity of the user, computing a sustainability score as a function of the first set of data, the second set data, and the third set of data, generating a ranking score for the user based on the computed sustainability score relative to a plurality of other users. The non-transitory computer-accessible medium may further include instructions for utilizing the sustainability score and/or the relative sustainability rank (associated with the user) to automated cashback rewards to further incentivize sustainable transactional practices.

### BRIEF DESCRIPTION OF THE DRAWINGS

Various embodiments of the present disclosure, together with further objects and advantages, may best be understood by reference to the following description taken in conjunction with the accompanying drawings.

FIG. 1A illustrates an exemplary process overview of an ESG impact analyzer based on operational input data and generated output actions, in accordance to some embodiments of the present disclosure.

FIG. 1B illustrate an exemplary system implementation for the ESG impact analyzer, in accordance to some embodiments of the present disclosure.

FIG. 2 illustrates an exemplary system implementation, for derivation of sustainability parameters from operational input data and a computational scoring model as a function of the sustainability parameters, in accordance to some embodiments of the present disclosure.

FIG. 3 illustrates an exemplary implementation for determining a product SKU level sustainability metadata based on user feedback acquisition, in accordance to some embodiments of the present disclosure.

FIG. 4 illustrates an operational overview of an exemplary process for automating dynamic cashback rates based on quantifying transactional sustainability factor and environmental impact, in accordance to some embodiments of the present disclosure.

FIG. 5 illustrates an operational overview of an exemplary process for determining a SKU level product sustainability metadata based on user feedback acquisition, in accordance to some embodiments of the present disclosure.

FIG. 6 is an illustration of an exemplary block diagram of an exemplary system, in accordance to some embodiments of the present disclosure.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Some embodiments of the present disclosure are directed to system and method for dynamic generation and adjustment of cashback rates based on a sustainability signature (e.g., environmental impact footprint) associated with a user's transactional behavior and purchasing pattern. In accordance to some embodiments of the present disclosure, a sustainability factor associated with transactional behavior of a user may be derived based on an analysis of a user's transactional data. Cashback rewards may then be dynamically generated based on a user environmental impact footprint to further incentivize sustainable and environmentally friendly transactional practices. As such, an operational aspect of sustainability-based dynamic cashback rate generation involves a derivation of a ESG-impact ranking score based on a user's transactional behavior. Accordingly, one aspect of the present disclosure is directed to a system and method for providing automated cashback and rewards services based on an environmental impact score computed from sustainability-related parameters extracted from a user's transactional data.

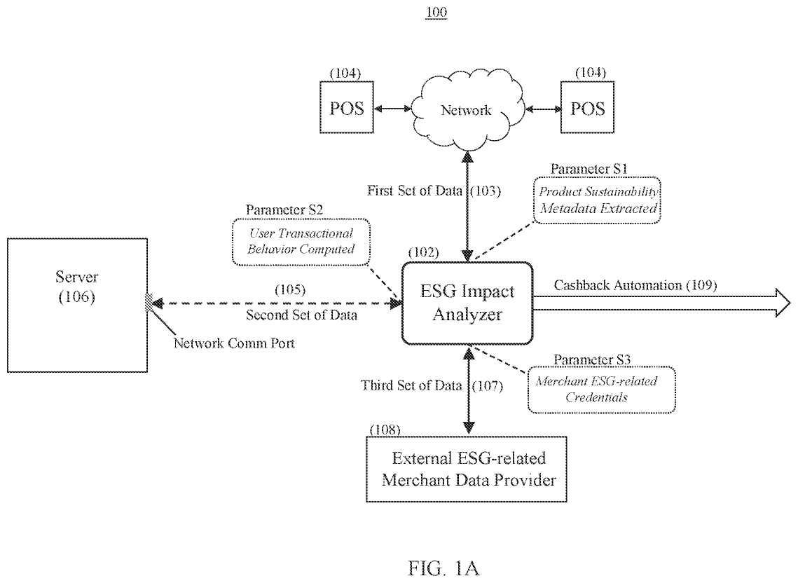

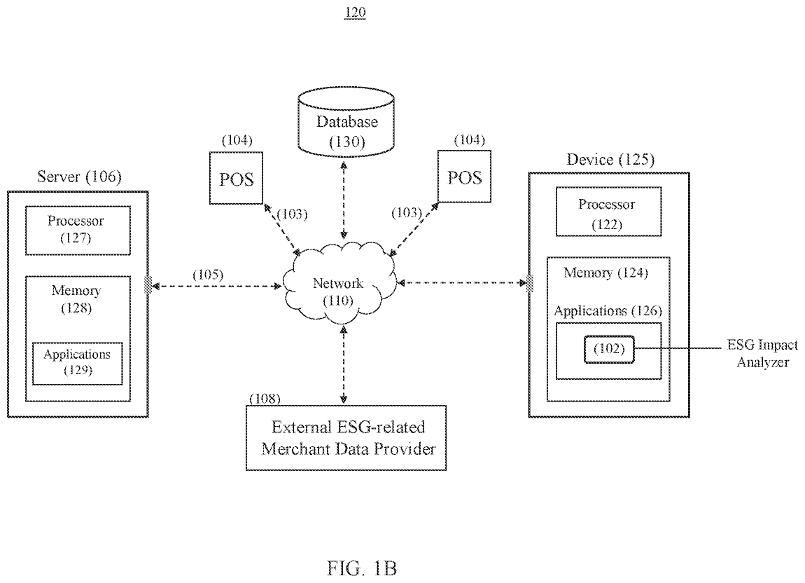

FIG. 1A illustrates an operational system overview (100) for utilizing a ESG impact analyzer (102) for dynamic generation of cashback rates. As shown in the system overview example (100), the automation of cashback rewards and adjustment rates, as facilitated by the operation of the ESG impact analyzer (102), is contingent upon a number of datasets (103, 105, 107) acquired as operational inputs and fed into the ESG impact computation process. The input datasets, retrieved from various external data sources (e.g., 104, 106, 108), are further processed by the ESG impact analyzer (102) to derive a set of (sustainability-related) input parameters (e.g., S1, S2, S3) for quantifying an environmental impact associated with various aspects of user's transactional behavior. With reference to example (100), a first dataset (103) may correspond to sustainability related product metadata generated by one or more point of sale (POS) devices (104). Accordingly, the first dataset (103) may be used towards computation of a first sustainability input parameter (S1) based on an assessment of sustainability attributes associated with products purchased by a user. Sustainability-related product metadata tags (used by the ESG impact analyzer for derivation of S1) may be inserted into a transaction string generated by a POS device. Sustainability-related product metadata may also be transmitted, by a POS device, via a data stream that is distinct from the transaction string.

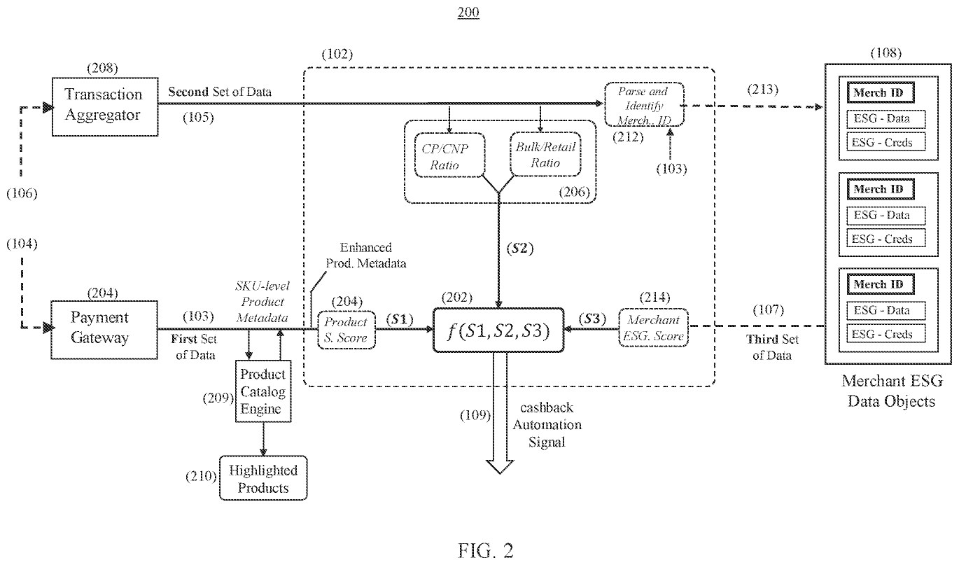

Referring back to FIG. 1, a second dataset (105), corresponding to a user's historical transactional records, may be retrieved from one or more corresponding account servers, linked to a user's transactional activities, and aggregated for further processing to assess a second aspect of user's transactional behavior associated with a user environmental impact footprint. A second aspect of a user's transactional activities, that may serve as a measure of the environmental impact footprint, may be quantified by computation of a second sustainability input parameter (S2). The second sustainability input parameter as derived from a second input dataset (105) may correspond to a set of numerical ratios for characterizing a carbon footprint and packaging waste associated with purchasing habits of the user. Examples of such numerical ratios for quantifying an environmental impact associated with a user's transactional behavior are provided in FIG. 2.

The second set of data (dataset 105), in addition to being processed for computation of the aforementioned numerical ratios, may be further parsed for identification of an associated merchant identifier. The extracted merchant identifiers may then be used to identify and retrieve a third dataset (107), corresponding to a merchant's ESG-related credentials. The third dataset (107) may then be used towards computation of a third sustainability input parameter (S3). ESG-related credential data associated with a merchant may be retrieved, for example, from an external data service provider (108) as shown, by the overview example 100, in FIG. 1.

The ESG impact analyzer (102) may be implemented as a process running on a device (125) as illustrated in the exemplary system implementation (120) illustrated in FIG. 1B. The exemplary system implementation (120), a network (110), the account server (106) (also illustrated in FIG. 1A and interchangeably referred to as server (106)), and a database (130). Although FIG. 1B illustrates single instances of components of system (120), system (120) may include any number of components.

The device (125) may include one or more processors (122), and memory (124). Memory (124) may include one or more applications, such as applications (126). According to the exemplary embodiment (120), the ESG impact analyzer (102) may be implemented as part of applications (126) stored on the device (125). The device (125) may be in data communication with any number of components of system (120). For example, device (125) may be configured as a central system, server or platform to control and call various data at different times to execute a plurality of workflow actions such as the ESG impact analyzer process (102). Device (125) may be configured to connect to server (106). Server (106) may be in data communication with the applications (126) running the ESG impact analyzer process (102). For example, the server (106) may be in data communication with applications (126) via one or more networks (110). The device (125) may transmit, for example from applications (126) executing thereon, one or more requests to server (106). The one or more requests may be associated with retrieving data from server (106). Server (106) may receive the one or more requests from device (125). Based on the one or more requests from processor (122) in data communication with applications (126), device (125) may be configured to retrieve the requested data. Device (125) may be configured to transmit the received data to the processor (122) in data communication with application 126). Without limitation, the device (125) may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a contactless card, a thin client, a fat client, an Internet browser, a kiosk, a tablet, a terminal, an ATM, or other device. The device (125) also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The device (125) may include processing circuitry and may contain additional components, including processors, memories, error and parity/CRC checkers, data encoders, anticollision algorithms, controllers, command decoders, security primitives and tamper-proofing hardware, as necessary to perform the functions described herein. The device (125) may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user's device that is available and supported by the user's device, such as a touch-screen, keyboard, mouse, cursor-control device, touch-screen, microphone, digital camera, video recorder or camcorder. These devices may be used to enter information and interact with the software and other devices described herein. The information used by the ESG impact analyzer process (102) running, for example, on the device (125) may comprise the first, second and third datasets (e.g., 103, 105, 107) retrieved across, for example, network (110). The first, second and third datasets maybe retrieved from the server (106), one or more POS devices (104), external data provider (108) and one or more databases (130)

In some examples, network (110) may be one or more of a wireless network, a wired network or any combination of wireless network and wired network, and may be configured to connect to any one of components of system (120). For example, the device (125) may be configured to connect to server (106) via network (110). In some examples, network (110) may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, network (110) may include, without limitation, telephone lines, fiber optics, IEEE Ethernet 902.3, a wide area network, a wireless personal area network, a LAN, or a global network such as the Internet. In addition, network (110) may support an Internet network, a wireless communication network, a cellular network, or the like, or any combination thereof. Network (110) may further include one network, or any number of the exemplary types of networks mentioned above, operating as a stand-alone network or in cooperation with each other. Network (110) may utilize one or more protocols of one or more network elements to which they are communicatively coupled. Network (110) may translate to or from other protocols to one or more protocols of network devices. Although network (110) is depicted as a single network, it should be appreciated that according to one or more examples, network (110) may comprise a plurality of interconnected networks, such as, for example, the Internet, a service provider's network, a cable television network, corporate networks, such as credit card association networks, and home networks.

As described with reference to FIG. 1A, transactional records, corresponding to a second set of data, may be retrieved from one or more account servers associated with a user and parsed and processed to compute a second sustainability input parameter as a function of online to in-person and bulk to retail transaction ratios. As shown in the exemplary system implementation (120), illustrated in FIG. 1B, account server (106) may include one or more processors (127) coupled to memory (128). The server (106) can be configured as a central system, server or platform to control and call various data at different times to execute a plurality of workflow actions. The server (106) can be configured to connect to any component of system (120) via network (110). The server (106) can be a dedicated server computer, such as bladed servers, or can be personal computers, laptop computers, notebook computers, palm top computers, network computers, mobile devices, wearable devices, or any processor-controlled device capable of supporting the system (120). While FIG. 1B illustrates a single server (106), it is understood that other embodiments can use multiple servers or multiple computer systems as necessary or desired to support the users and can also use back-up or redundant servers to prevent network downtime in the event of a failure of a particular server.

The server (106) can be in data communication with the processor (122). For example, server 106) can be in data communication with processor (122) of the device (125) via one or more networks (110). The device (125) may transmit one or more requests to the server (106). The one or more requests can be associated with retrieving data from the server (106). The server (106) can receive the one or more requests from any component of device (125). Based on the one or more requests from, for example the processor (122), the server (106) can be configured to transmit the requested data. The server (106) can be configured to transmit the requested data to the processor (122) of the device (125), the transmitted data being responsive to one or more requests.

The server (106) can include a processor (127). The processor (127) can be, for example, one or more microprocessors. The processor (127) can include processing circuitry, which can contain additional components, including additional processors, memories, error and parity/CRC checkers, data encoders, anti-collision algorithms, controllers, command decoders, security primitives and tamper-proofing hardware, as necessary to perform the functions described herein.

The server (106) can include an application (129) comprising instructions for execution thereon. For example, the application can reside in memory (128) of server (106) and can comprise instructions for execution on the server (106). The application (129) of the server (106) can be in communication with any components of system (120). For example, server (106) can execute one or more applications that enable, for example, network and/or data communications with one or more components of system (120) and transmit and/or receive data. Without limitation, the server (106) can be a network-enabled computer. As referred to herein, a network-enabled computer can include, but is not limited to a computer device, or communications device including, e.g., a server, a network appliance, a personal computer, a workstation, a phone, a handheld PC, a personal digital assistant, a contactless card, a thin client, a fat client, an Internet browser, or other device. The server (106) also can be a mobile device; for example, a mobile device can include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server (106) can include processing circuitry and can contain additional components, including processors, memories, error and parity/CRC checkers, data encoders, anticollision algorithms, controllers, command decoders, security primitives and tamper-proofing hardware, as necessary to perform the functions described herein. The server (106) can further include a display and input devices. The display can be any type of device for presenting visual information such as a computer monitor, a flat panel display, and a mobile device screen, including liquid crystal displays, light-emitting diode displays, plasma panels, and cathode ray tube displays. The input devices can include any device for entering information into the user's user device that is available and supported by the user's user device, such as a touch-screen, keyboard, mouse, cursor-control device, touch-screen, microphone, digital camera, video recorder or camcorder. These devices can be used to enter information and interact with the software and other devices described herein.

System (120) can include one or more databases (130). The database (130) can comprise a relational database, a non-relational database, or other database implementations, and any combination thereof, including a plurality of relational databases and non-relational databases. In some examples, the database (130) can comprise a desktop database, a mobile database, or an in-memory database. Further, the database (130) can be hosted internally by any component of system (120), such as the device (125), or server (106), or the database (130) can be hosted externally to any component of the system (120), such as the device (125), or server (106), by a cloud-based platform, or in any storage device that is in data communication with the device (125) and server (106). In some examples, the database (130) can be in data communication with any number of components of system (120). For example, the server (106) can be configured to retrieve the data requested by processor (122) of the device (125) from the database (130). Server (106) can be configured to transmit the received data from database (130) to the processor (122) via network (110), the received data being responsive to the transmitted one or more requests. In other examples, the processor (122) can be configured to transmit one or more requests for the requested data to the database (130) via network (110).

FIG. 2 illustrated an operational overview (200) for automated generation of instructions for implementing dynamic cashback reward services based on a sustainability computational model (202), running, for example, as part of the ESG impact analyzer process (102). The operational overview example (200), further illustrates are a set of processes (204, 206, 214) for derivation of the operational input parameters (S1, S2, S3). The dynamic computation of cashback rates, as represented by the automation signal (109), may then be performed as a function of the operational input parameters.

With reference to operational overview example (200), a first sustainability-related parameter (S1) may be computed from the first set of data (103) collected from a plurality of POS devices by a payment gateway (204). The first data set (103) may then be parsed and analyzed for extraction of product sustainability-related metadata used in derivation of the first sustainability-related input parameters (S1). In some instances, metadata with respect to sustainable attributes of a product may not be provided (or partially provided) by a transacting POS device. In such instances, a stock keeping unit (SKU) identifier may be extracted from the POS generated data and fed into a product catalog engine (209). The product catalog engine may then identify one or more product metadata associated with sustainability attributes of a product. The SKU-level metadata associated with sustainable attributes of the product, as provided by the product catalog engine (209), may then be used to enhance the sustainability metadata used by process (204) to derive the first input parameter (S1), which is fed into the computational model (202).

In accordance to some embodiments, computation of a product sustainability factor (e.g., a product sustainability score) from a set of identified sustainability-related product metadata tags may involve mapping the one or more metadata tags, extracted from the POS generated data and/or provided by the product catalog engine, to a pre-determined set of sustainability-related metrics. The process may further involve computation of a set of weighing coefficients for the pre-determined set of sustainability-related metrics, based on the identified metadata. The information, corresponding to product sustainability-related metrics and weighing coefficients, as derived from the identified and enhanced sustainability-related metadata, may then be used by a process (204) to derive a numerical value for the sustainability parameter (S1), as illustrated in FIG. 2.

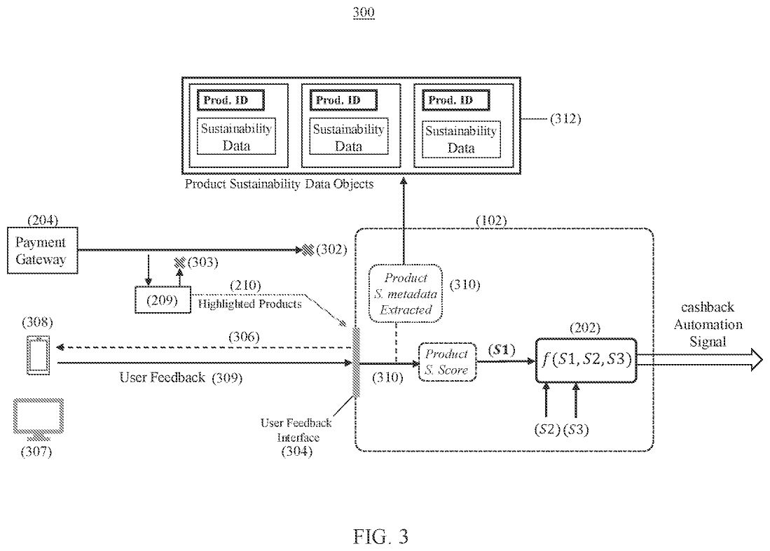

In some instances, metadata characterizing a product in terms of its sustainability attributes may not be provided by a POS device or identifiable by a product catalog engine (209). In accordance to some embodiments of the present disclosure, product identifiers corresponding to products with missing sustainability-related metadata may be highlighted (210) and separately processed based on a user-feedback acquisition process, as further illustrated in FIG. 3.

Referring back to example (200), a second input parameters (S2) for quantifying an environmental impact arising from a user's transactional activities, may be computed from the second set of data (105). The second set of data (105) may correspond to a user's transaction records as recorded and archived by one or more corresponding account servers (106), and retrieved using a transaction aggregator (208). The transaction aggregator (208) may be linked to one or more financial accounts associated with the user and operative to retrieve data records corresponding to transaction history archived by the one or more account servers (106). The second set of data (105) may then be parsed and analyzed to determine an environmental impact associated, for example, with consumption of fossil fuels and packaging waste resulting from a user's transactional activities and purchasing pattern. According to some embodiment, a quantitate measure for the second input parameter (S2) may be computed as a function of numerical ratios reflecting a degree of online to in-person transactions and a degree of bulk to retails transactions conducted by the user. Online-initiated purchases, may be tagged as card-not-present (CNP) transactions associated with network transmitted payment information, while in-person transaction may be tagged as card-present (CP) transactions associated with direct capture of payment information from a physical payment card. CNP and CP designation for a transaction may be encoded in the transactional records retrieved by the transaction aggregator (208) from one or more account servers linked to a user's transactional activities. Similarly, bulk and retail transactions may be determined based on data encoded in the transactional records, such as a transaction amount. The transactional records, corresponding to the second dataset (105), may then be parsed and analyzed for computation of CP to CNP and bulk to retail transaction ratios and used by the process (206) to derive the second operational input parameters (S2), as a function of the aforementioned ratios.

Aggregated transactional records may also be used for extraction of associated merchant identifiers, by a process (212), running as part of the ESG impact analyzer (102), and used as an index for identification and retrieval of the third set of data (107). The third dataset (107) may be used in derivation of a third sustainability-related input parameter (S3). For example, the ESG impact analyzer process (102) may generate a network request (213) to an external data provider (108) storing information related to a merchant compliance with recognized ESG sustainability standards. The third set of data (107), provided by an external data provider (108), in response to the request message (213), may then be used by a receiving process (214), that may be running as part of the ESG impact analyzer process (102), for quantifying a sustainability performance of a merchant associated with a user's transactional data. Such sustainability performance metrics and ESG data (e.g., third set of data 107) may be reported by a merchant's parent corporation and/or provided by third-party entities that measure and track key ESG-impact indicators such as water and energy consumption, waste generation and greenhouse gas emission across various organization.

In accordance to some embodiments, externally retrieved ESG-related merchant data may be assigned coefficient values based on a mapping against various sustainability criteria and fed into a process (214) to measure environmental impact arising from a specific merchant's operational practices and initiatives. In some embodiments, the third sustainability-related data set may correspond to a merchant ESG ranking score retrieved from a third-party entity and directly used for determination of a third sustainability parameter (S3).

The computational model (202) may perform one or more machine learning routine and data analytics operations on the internally/externally collected product metadata, user transactional data and merchant information to provide compute a sustainability score based on various aspects of user's purchasing pattern and transactional behavior. The incorporated machine learning processes may utilize information from various mobile applications (e.g., GPS data) running on a user's device in order to produce a more accurate score based on detection of patterns in a user's transactional and/or electronically-recorded activity patterns, various exemplary models can be generated, for example, for modelling such electronically recorded activities. The exemplary system, method and computer-accessible medium can then apply the generated models for various user-related activity parameters to current evaluation of a user ESG impact footprint.

According to some embodiments, one or more data analytics and machine learning routines may be applied to supplement the computation of transactional activity patterns/parameters based on detection of relevant patterns in the transactional and other electronically-recorded user activities that may be indicative of an environmental footprint and sustainability factor associated with user's transactional and/or purchasing behavior. This may be supplemented by a use of various prediction models such as ones that can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

The exemplary system, method and computer-accessible medium can utilize various neural networks, such as convolutional neural networks (CNNs) or recurrent neural networks (RNNs), to generate the exemplary models. A CNN can include one or more convolutional layers (e.g., often with a subsampling step) and then followed by one or more fully connected layers as in a standard multilayer neural network. CNNs can utilize local connections, and can have tied weights followed by some form of pooling which can result in translation invariant features.

A RNN is a class of artificial neural network where connections between nodes form a directed graph along a sequence. This facilitates the determination of temporal dynamic behavior for a time sequence. Unlike feedforward neural networks, RNNs can use their internal state (e.g., memory) to process sequences of inputs. A RNN can generally refer to two broad classes of networks with a similar general structure, where one is finite impulse and the other is infinite impulse. Both classes of networks exhibit temporal dynamic behavior. A finite impulse recurrent network can be, or can include, a directed acyclic graph that can be unrolled and replaced with a strictly feedforward neural network, while an infinite impulse recurrent network can be, or can include, a directed cyclic graph that may not be unrolled. Both finite impulse and infinite impulse recurrent networks can have additional stored state, and the storage can be under the direct control of the neural network. The storage can also be replaced by another network or graph, which can incorporate time delays or can have feedback loops. Such controlled states can be referred to as gated state or gated memory, and can be part of long short-term memory networks (“LSTMs”) and gated recurrent units.

RNNs can be similar to a network of neuron-like nodes organized into successive “layers,” each node in a given layer being connected with a directed e.g., (one-way) connection to every other node in the next successive layer. Each node (e.g., neuron) can have a time-varying real-valued activation. Each connection (e.g., synapse) can have a modifiable real-valued weight. Nodes can either be (i) input nodes (e.g., receiving data from outside the network), (ii) output nodes (e.g., yielding results), or (iii) hidden nodes (e.g., that can modify the data enroute from input to output). RNNs can accept an input vector x and give an output vector y. However, the output vectors are based not only by the input just provided in, but also on the entire history of inputs that have been provided in in the past.

For supervised learning in discrete time settings, sequences of real-valued input vectors can arrive at the input nodes, one vector at a time. At any given time step, each non-input unit can compute its current activation (e.g., result) as a nonlinear function of the weighted sum of the activations of all units that connect to it. Supervisor-given target activations can be supplied for some output units at certain time steps. For example, if the input sequence is a speech signal corresponding to a spoken digit, the final target output at the end of the sequence can be a label classifying the digit. In reinforcement learning settings, no teacher provides target signals. Instead, a fitness function, or reward function, can be used to evaluate the RNNs performance, which can influence its input stream through output units connected to actuators that can affect the environment. Each sequence can produce an error as the sum of the deviations of all target signals from the corresponding activations computed by the network. For a training set of numerous sequences, the total error can be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. This, for example, may apply to user transactional activity analyzed in conjunction, for example, with navigation data from a user mobile device. In other examples, the training datasets may comprise continuously-collected data based on the current operation of the instant system and continuously-collected data from the operation of other systems (i.e., real-time tracking of electronic transaction data and the data from a user's GPS application.) In some examples, the training dataset may include anticipated data, such as the anticipated future travel pattern and purchasing action pattern, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, the predictive models described herein may be training prior to use and the training may continue with updated data sets that reflect additional information.

FIG. 3 illustrates an example embodiment (300) directed to scenarios wherein SKU-level metadata related to a products sustainability attributes may not be provided by a transacting POS devices, as represented by a failed extraction process (302), or identifiable by a product catalog engine as, represented by a failed identification process (303). As shown in FIG. 3, product identifiers (e.g., SKU identifier) associated with POS transaction strings with missing product metadata may be highlighted for separate processing with a user feedback acquisition interface (304). Some embodiments of the present disclosure, facilitate acquisition of a product sustainability-related metadata (e.g., first set of data 103), for highlighted products 210, via request (306) transmitted, by the user-feedback interface (304), to a user device (e.g., computing device 307 and/or mobile device 308). The user-feedback interface (304) may be configured to receive (user feedback) data 309, captured and transmitted by a respective user device (e.g., mobile device 308).

The user captured data may correspond, for example, to scanned copies of product transaction receipts. The user-provided product information may then be parsed and processed to extract the relevant product metadata tags indicative of the product's sustainability attributes. In some embodiments, the user-feedback interface (304) may be further configured for acquisition of image data corresponding, for example, to the product indicia (e.g., as printed on a portion of the product's surface and/or the product's packaging). The image data may be captured, for example, by a user mobile device (308) running a client interface application, and communicated to the user-feedback interface (304) across a public network. The image data may then be parsed and processed for extraction of metadata tags and/or codes indicative of the product's sustainability attributes.

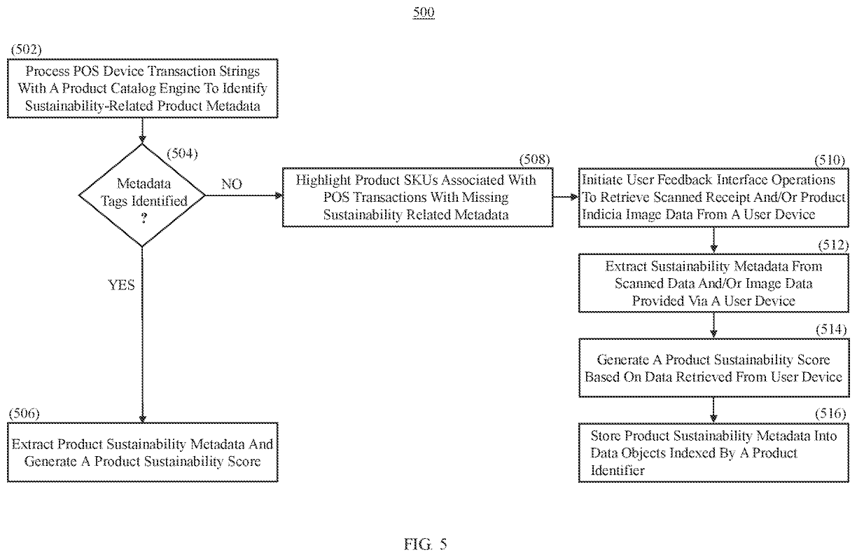

In some embodiments, the extracted product sustainability-related metadata (310) may be compiled and stored in a product metadata datastore (312), as data objects comprising a product identifier and sustainability-related product metadata. The operation of the user-feedback acquisition interface (304) is further described with reference to a flow diagram illustrated in FIG. 5.

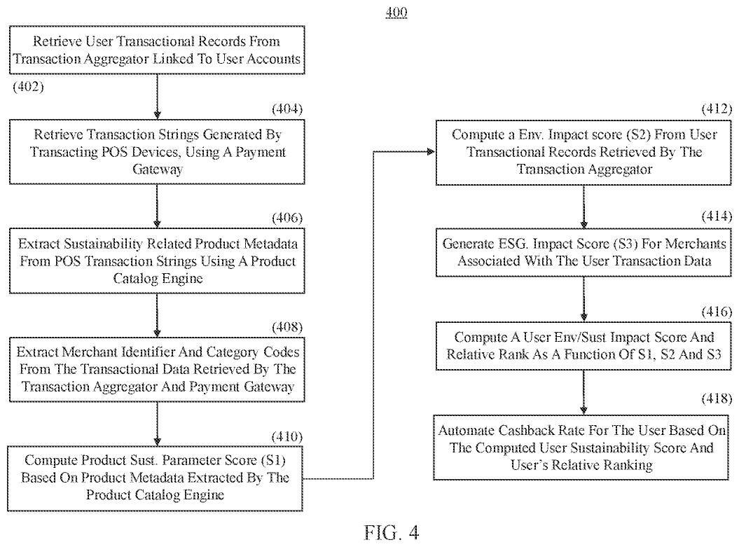

FIG. 4 illustrates an operational flow diagram (400) for implementing a dynamic cashback automation service based on an environmental-impact footprint as determined from a user's transactional data.

As described above, one aspect of the environmental-impact footprint, derived from a user transactional data, may be characterized in terms of the environmentally-friendly transactional practices associated, for example, with reduced packaging waste and greenhouse gas emission resulting from transactional activities of the user. In accordance to some embodiments, this may be determined from analyzing a user's recorded transaction history to identify online versus in person and bulk versus retail transactions. As such, with reference to the operational flow diagram (400), step (402) is directed to the retrieval of a user's transaction records implemented by linking a transactions aggregator to one or more financial accounts associated with a user.

Another aspect of the environmental-impact footprint, derived from a user transactional data, may be characterized in terms of the sustainability-related product attributes associated with a user's purchasing pattern. For example, if a user has a relatively low impact on the environment, reflected by purchasing behaviors directed to more sustainable products and/or plant based protein, and a smaller fossil fuel footprint as reflected for example, by a user's transportation choice (e.g., metro pass, bus pass, UberPool, electric vehicles charge fee rather than gas station fuel purchases), the user may benefit from a higher cashback rates. Accordingly, the implementation of a dynamic cashback reward automation based on environmental-impact footprint may further involve quantification of a sustainability factor associated with a user's (product) purchasing choices. Therefore another sustainability parameter derived from the user transactional data may correspond to a sustainability factor associated with a user product choices, in particular sustainability attributes of the products generally purchased by the user. Such product information may be identified based on specific metadata tags and codes inserted into a transaction string and/or generated in conjunction with a transaction string by a point of sale (POS) device. Retrieval of POS generated transaction strings (and product metadata) by a payment gateway is represented by step (404). In some instances wherein relevant product data (e.g., product sustainability metadata tags) are not provided by a respective POS device, a product catalog engine may be used to generate the relevant sustainability-related product metadata, based on, for example, a product SKU identifier, as represented by step (406).

In addition to sustainability factors of purchased products and environmental impact associated with transactional activities of a user, another sustainability factor (e.g., a third sustainability input parameter) derived from a user's transactional data, may corresponds to the ESG rating of the merchants associated with a user's transactional activity (e.g., products purchasing activity, such as groceries, fuel, amenities, etc.). Accordingly, step (408) is directed to extraction of a merchant identifier and/or a category code, from user's transactional data (retrieved in steps 402, 404), and identification of one or more sustainability metrics for the corresponding merchants. Incorporating merchant ESG rating scores as a factor in automation of user cashback rewards may incentivize transactions with merchants having a higher sustainability rating and credentials as determined, for example, by international standards and certificates indicative of environmentally friendly operation and/or reduced ESG impact. Such merchant ESG rating information may be provided by the merchant with respect to their sustainable and environmentally friendly practices and/or retrieved from third party entities, such as Google carbon calculator.

Once the required sets of data to facilitate derivation of input sustainability parameters (e.g., as associated with sustainable product choice, environmentally friendly purchasing behavior and merchant choice) is acquired and/or extracted, a first, second and third sustainability input parameters may be respectively computed as represented by steps (410), (412) and (414).

For example, step (412) is directed to a computation of a sustainability factor based on sustainability metadata tags associated with products purchased by the user. At step (412), the parsed and processed transactional data may be used to compute a measure of a user's environmentally friendly transactional behavior as characterized, for example, by a ratio of online to in person and/or bulk to retail purchasing patterns. As step (414), extracted merchant identifiers may be used to identify and/or generate a ESG impact score for the corresponding merchants associated with the user's transactional data.

At step (416), a user transactional sustainability and environmental impact score may then be computed as a function of the input sustainability parameters derived in steps (410), (412) and (414), to characterize the environmental impact footprint and a degree of sustainability associated with a user's transactional practices. The user transactional sustainability and environmental impact score may be used to generate a ranking score for the user based on similar scores computed for a plurality of other users. At step (418), automated cashback adjustment rates are dynamically implemented for the user based on the user's relative ranking score (e.g., relative to a plurality of other users) as computed in step (416).

FIG. 5 illustrates an operational flow diagram (500) for incorporation of a user feedback acquisition process for deriving the first set of data corresponding to a product's sustainability metadata in situation wherein the relevant metadata tags may not be provided by a transacting POS device and/or a product catalog engine. As described above, a product catalog engine may be used to identify and extract such metadata tags based on, for example, a product SKU identifier, which may be inserted into a transaction string generated by a corresponding POS device. However, there may be scenario wherein a product catalog engine is also unable to identify and retrieve the necessary metadata tags required for determining a sustainability factor associated with a product. In such scenarios required metadata tags may be printed on a physical receipt associated with the transaction and/or provided as indicia printed onto the product itself and/or the product packaging.

Referring back to FIG. 5, at step (502) of the operational flow diagram (500), POS generated transaction data (inserted into a transaction string and/or provided via a separate data stream by a transacting POS device) may be parsed and processed to identify any sustainability related metadata tags associated with a product being purchased by a user. At step (504) a determination is made as to the whether the sustainability metadata tags are available in the POS generated data and/or obtainable with a product catalog engine. If the relevant metadata tags are identified either from a POS transaction string or a product catalog engine, the process may move to step (506) to extract the product sustainability metadata for generation of a product sustainability score. However, if the required metadata tags, for a particular product, cannot be identified and/or extracted at step (504), the corresponding product identifier (e.g., SKU identifier) may be highlighted at step (508) for separate processing via a user-feedback acquisition routine. Upon detection of one or more highlighted products identifiers at step (508), a user-feedback acquisition process as facilitated, for example, by a user-feedback interface, is invoked at step (510). In accordance to the operation initiated at step (510), a request signal may be transmitted to a previously registered user device, prompting a user to capture one or more scanned copies of transaction receipts and/or product image showing printed product indicia. At step (512), the user-provided data, captured via a user mobile and/or computing device, may then be transmitted back to the user-feedback interface and accordingly processed for extraction of a product sustainability metadata.

At step (514) a product sustainability score may be generated based on data retrieved from one or more user devices. At step 516, the extracted product sustainability metadata may be stored as data objects indexed, for example, by a SKU identifier associated with the product. The extracted metadata may further be used to update a product catalog database and/or a third party product database.

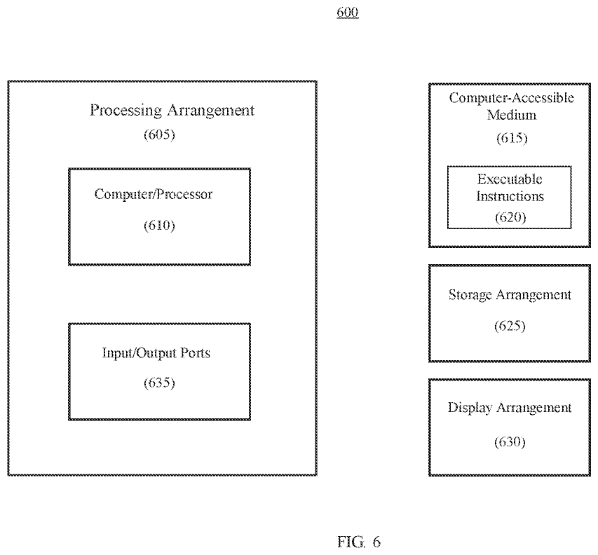

FIG. 6 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement) (605). Such processing and/or computing arrangement (605) can be, for example entirely or a part of, or include, but not limited to, a computer and/or processor (610) that can include, for example one or more microprocessors, and use instructions stored on a computer-accessible medium (e.g., RAM, ROM, hard drive, or other storage device).

As shown in FIG. 6, for example a computer-accessible medium (615) (e.g., as described herein above, a storage device such as a hard disk, floppy disk, memory stick, CD-ROM, RAM, ROM, etc., or a collection thereof) can be provided (e.g., in communication with the processing arrangement 605). The computer-accessible medium (615) can contain executable instructions (620) thereon. In addition or alternatively, a storage arrangement (625) can be provided separately from the computer-accessible medium (615), which can provide the instructions to the processing arrangement (605) so as to configure the processing arrangement to execute the exemplary procedures, processes, and methods, as described herein above, for example.

Further, the exemplary processing arrangement (605) can be provided with or include an input/output ports (635), which can include, for example a wired network, a wireless network, the internet, an intranet, a data collection probe, a sensor, etc. As shown in FIG. 6, the exemplary processing arrangement (605) can be in communication with an exemplary display arrangement (630), which, according to certain exemplary embodiments of the present disclosure, can be a touch-screen configured for inputting information to the processing arrangement in addition to outputting information from the processing arrangement, for example. Further, the exemplary display arrangement (630) and/or a storage arrangement (625) can be used to display and/or store data in a user-accessible format and/or user-readable format.

Systems and methods described herein can provide secure, retrieval of sensitive user information or enabling streamlined communication and processing of sensitive user information for example, for facilitating secure electronic transactions. Once a valid authorization response from an authenticated user has been established, the automated data retrieval and transfer systems and processes can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions.

In some aspects, the techniques described herein relate to a method for quantifying a sustainability factor associated with user transactional data, the method including: linking a transaction aggregator to one or more financial accounts associated with a user to retrieve a transaction history of the user; retrieving, from one or more Point Of Sale (POS) devices, one or more transaction strings including product data associated with one or more transactions conducted by the user; processing user transactional activity including the transaction history and the one or more transaction strings to: identify a first set of data associated with one or more product metadata tags indicative of one or more sustainability related product attributes, identify one or more merchants associated with the user transactional activity, and compute a second set of data including a ratio of online to in-person transactions and a ratio of bulk to retail transactions; retrieving a third set of data corresponding to one or more sustainability credentials of the one or more merchants associated with the user transactional activity; computing a sustainability score as a function of the first set of data, the second set data, and the third set of data; and generating a ranking score for the user based on the computed sustainability score relative to a plurality of other users.

In some aspects, the techniques described herein relate to a method, wherein the first set of data is generated by processing one or more Stock Keeping Unit (SKU) identifiers, associated with one or more user transactions, with a product catalog engine.

In some aspects, the techniques described herein relate to a method, wherein the one or more transaction strings are retrieved from the one or more POS devices using one or more payment processors.

In some aspects, the techniques described herein relate to a method, wherein the first set of data is obtained from one or more scanned copies of transaction receipts provided by the user.

In some aspects, the techniques described herein relate to a method, wherein the second set of data and one or more merchant identifiers associated with the one or more merchants are obtained from one or more scanned copies of transaction receipts provided by the user.

In some aspects, the techniques described herein relate to a method, further including, calculating a cashback reward value based on the ranking score of a user.

In some aspects, the techniques described herein relate to a method, wherein a computation of the sustainability factor associated with a user transactional data is initiated upon receiving an authorization response from the user.

In some aspects, the techniques described herein relate to a method, wherein a user feedback acquisition process is used to determine the first set of data for one or more products, associated with one or more transaction strings, for which the first set of data is not available.

In some aspects, the techniques described herein relate to a system for computing a sustainability factor from user transaction activity, the system including a computer hardware arrangement configure to: link a transaction aggregator to one or more financial accounts associated with a user, to retrieve a transaction history of the user; retrieve, from one or more Point Of Sale (POS) devices, one or more transaction strings including product data associated with one or more transactions conducted by the user; process the transaction history and the one or more transaction strings to: identify a first set of data associated with one or more product metadata tags indicative of one or more sustainability related product attributes, identify one or more merchants associated with a transactional activity of the user, and compute a second set of data including a ratio of online to in-person transactions, and a ratio of bulk to retail transactions, associated with the user; retrieve a third set of data corresponding to one or more sustainability credentials of the one or more merchants associated with the transactional activity of the user; compute a sustainability score as a function of the first set of data, the second set data, and the third set of data; and generate a ranking score for the user based on the computed sustainability score relative to a plurality of other users.

In some aspects, the techniques described herein relate to a system, wherein the system is configured to generate the first set of data by processing one or more Stock Keeping Unit (SKU) identifiers, associated with one or more user transactions, with a product catalog engine.

In some aspects, the techniques described herein relate to a system, wherein the system is configured to retrieve the one or more transaction strings from the one or more POS devices using one or more payment processors.

In some aspects, the techniques described herein relate to a system, wherein the system is configured to obtain the first set of data from one or more scanned copies of transaction receipts provided by the user.

In some aspects, the techniques described herein relate to a system, wherein the system is further configured to obtain the second set of data and one or more merchant identifiers associated with the one or more merchants, from the one or more scanned copies of transaction receipts provided by the user.

In some aspects, the techniques described herein relate to a system, wherein the system is further configures to calculate a cashback reward value based on the ranking score of a user.

In some aspects, the techniques described herein relate to a system, wherein the system is further configured to initiate a computation of the sustainability factor upon receiving an authorization response from the user.

In some aspects, the techniques described herein relate to a system, wherein the system is further configured to determine the first set of data for one or more products, for which the first set of data is not available, via a user feedback acquisition process.

In some aspects, the techniques described herein relate to a non-transitory computer-accessible medium including instructions for execution by a computer hardware arrangement, wherein upon execution of the instructions the computer hardware arrangement is configured to perform procedure including: linking a transaction aggregator to one or more financial accounts associated with a user, to retrieve a transaction history of the user; retrieving, from one or more Point Of Sale (POS) devices, one or more transaction strings including product data associated with one or more transactions conducted by the user; processing the transaction history and the one or more transaction strings to: identify a first set of data associated with one or more product metadata tags indicative of one or more sustainability related product attributes; identify one or more merchants associated with a transactional activity of the user; compute a second set of data including a ratio of online to in-person transactions, and a ratio of bulk to retail transactions, associated with the user; retrieving a third set of data corresponding to one or more sustainability credentials of the one or more merchants associated with the transactional activity of the user; computing a sustainability score as a function of the first set of data, the second set data, and the third set of data; generating a ranking score for the user based on the computed sustainability score relative to a plurality of other users.

In some aspects, the techniques described herein relate to a non-transitory computer-accessible medium, further including instructions for processing one or more Stock Keeping Unit (SKU) identifiers, associated with one or more user transactions, with a product catalog engine to generate the first set of data.

In some aspects, the techniques described herein relate to a non-transitory computer-accessible medium, further including instruction for calculating a cashback reward value based on the ranking score of a user.

In some aspects, the techniques described herein relate to a non-transitory computer-accessible medium, further including instruction for generating the first set of data from one or more scanned copies of transaction receipts provided by the user.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method for quantifying a sustainability factor associated with user transactional data, the method comprising:
linking a transaction aggregator to one or more financial accounts associated with a user to retrieve a transaction history of the user;
retrieving, from one or more Point Of Sale (POS) devices, one or more transaction strings comprising product data associated with one or more transactions conducted by the user;
processing user transactional activity comprising the transaction history and the one or more transaction strings to:
identify a first set of data associated with one or more product metadata tags indicative of one or more sustainability related product attributes,
identify one or more merchants associated with transactional activity of the user, and
compute a second set of data comprising a ratio of online to in-person transactions and a ratio of bulk to retail transactions;
retrieving a third set of data corresponding to one or more sustainability credentials of the one or more merchants associated with transactional activity of the user;
computing a sustainability score as a function of the first set of data, the second set of data, and the third set of data; and
generating a ranking score for the user based on the sustainability score computed relative to a plurality of other users.

2. The method of claim 1, wherein the first set of data is generated by processing one or more Stock Keeping Unit (SKU) identifiers, associated with one or more user transactions, with a product catalog engine.

3. The method of claim 1, wherein the one or more transaction strings are retrieved from the one or more POS devices using one or more payment processors.

4. The method of claim 1, wherein the first set of data is obtained from one or more scanned copies of transaction receipts provided by the user.

5. The method of claim 4, wherein the second set of data and one or more merchant identifiers associated with the one or more merchants are obtained from one or more scanned copies of transaction receipts provided by the user.

6. The method of claim 1, further comprising, calculating a cashback reward value based on the ranking score of a user.

7. The method of claim 1, wherein a computation of the sustainability factor associated with a user transactional data is initiated upon receiving an authorization response from the user.

8. The method of claim 1, wherein a user feedback acquisition process is used to determine the first set of data for one or more products, associated with one or more transaction strings, for which the first set of data is not available.

9. A system for computing a sustainability factor from user transaction activity, the system comprising a computer hardware arrangement configure to:
link a transaction aggregator to one or more financial accounts associated with a user, to retrieve a transaction history of the user;
retrieve, from one or more Point Of Sale (POS) devices, one or more transaction strings comprising product data associated with one or more transactions conducted by the user;
process the transaction history and the one or more transaction strings to:
identify a first set of data associated with one or more product metadata tags indicative of one or more sustainability related product attributes,
identify one or more merchants associated with a transactional activity of the user, and
compute a second set of data comprising a ratio of online to in-person transactions, and a ratio of bulk to retail transactions, associated with the user;
retrieve a third set of data corresponding to one or more sustainability credentials of the one or more merchants associated with the transactional activity of the user;
compute a sustainability score as a function of the first set of data, the second set of data, and the third set of data; and
generate a ranking score for the user based on the sustainability score computed relative to a plurality of other users.

10. The system of claim 9, wherein the system is configured to generate the first set of data by processing one or more Stock Keeping Unit (SKU) identifiers, associated with one or more user transactions, with a product catalog engine.

11. The system of claim 9, wherein the system is configured to retrieve the one or more transaction strings from the one or more POS devices using one or more payment processors.

12. The system of claim 9, wherein the system is configured to obtain the first set of data from one or more scanned copies of transaction receipts provided by the user.

13. The system of claim 12, wherein the system is further configured to obtain the second set of data and one or more merchant identifiers associated with the one or more merchants, from the one or more scanned copies of transaction receipts provided by the user.

14. The system of claim 9, wherein the system is further configures to calculate a cashback reward value based on the ranking score of a user.

15. The system of claim 9, wherein the system is further configured to initiate a computation of the sustainability factor upon receiving an authorization response from the user.

16. The system of claim 9, wherein the system is further configured to determine the first set of data for one or more products, for which the first set of data is not available, via a user feedback acquisition process.

17. A non-transitory computer-accessible medium comprising instructions for execution by a computer hardware arrangement, wherein upon execution of the instructions the computer hardware arrangement is configured to perform procedure comprising:
linking a transaction aggregator to one or more financial accounts associated with a user, to retrieve a transaction history of the user;
retrieving, from one or more Point Of Sale (POS) devices, one or more transaction strings comprising product data associated with one or more transactions conducted by the user;
processing the transaction history and the one or more transaction strings to:
identify a first set of data associated with one or more product metadata tags indicative of one or more sustainability related product attributes;
identify one or more merchants associated with a transactional activity of the user;
compute a second set of data comprising a ratio of online to in-person transactions, and a ratio of bulk to retail transactions, associated with the user;
retrieving a third set of data corresponding to one or more sustainability credentials of the one or more merchants associated with the transactional activity of the user;
computing a sustainability score as a function of the first set of data, the second set of data, and the third set of data; and
generating a ranking score for the user based on the sustainability score computed relative to a plurality of other users.

18. The non-transitory computer-accessible medium of claim 17, further comprising instructions for processing one or more Stock Keeping Unit (SKU) identifiers, associated with one or more user transactions, with a product catalog engine to generate the first set of data.

19. The non-transitory computer-accessible medium of claim 17, further comprising instruction for calculating a cashback reward value based on the ranking score of a user.

20. The non-transitory computer-accessible medium of claim 17, further comprising instruction for generating the first set of data from one or more scanned copies of transaction receipts provided by the user.
